(19) United States
(12) Patent Application Publication
(10) Pub. No.: US 2003/0061333 A1
(43) Pub. Date: Mar. 27, 2003

(54) System and method for universal networked device management

(76) Inventors: Stephen Dean, Snohomish, WA (US); Art Millican, Granite Falls, WA (US); Jonathan David Fletcher, Everett, WA (US); Kirk David Stewart, Everett, WA (US); Cheri Kirchmeier, Woodinville, WA (US); Jaye Jarchow, Snohomish, WA (US); Nguyet Phan, Lynnwood, WA (US); Joe Putnam, Cedar Rapids, IA (US); Anthony Carter, Lynnwood, WA (US)

Correspondence Address: ORUM & ROTH, 53 W. JACKSON BLVD, CHICAGO, IL, 60604, US

(21) Appl. No.: 10/138,340

(22) Filed: May 3, 2002

Related U.S. Application Data
(60) Provisional application No. 60/289,023, filed on May 4, 2001.

(51) Int. Cl. G06F 15/173; G06F 15/16

(52) U.S. Cl. 709/223; 709/203

(57) ABSTRACT

The invention permits network management services, utilized by a user via a software based console, used on any network connected device, viewed as a web page via the internet. Dynamic updating of the devices available to the console is performed by a Multicast Discovery Protocol. Multicast Remote Procedure Calls permit simultaneous command processing among an authorized target group of devices. A Multicast File Transfer Protocol permits time and bandwidth efficient one to many file transfers via a data stream at a pre-specified address which many clients simultaneously monitor. Hand shaking for the transfer is rotated among the clients so that they may each recover any lost data frames. Use of client registries for storing network data allows clients to be automatically configured upon connection to the network. Virtual monitoring and control over the clients may be exercised from the console by executing remote procedure calls.

This application claims the benefit of U.S. Provisional Application No. 60/289,023 filed May 4, 2001, which is hereby incorporated by reference in its entirety.

### BACKGROUND

Previously, management of network connected devices involved separate configuration routines for each device. A separate management application for each individual or family of devices was used for device communication, monitoring and configuration. The various management applications needed for a diverse range of devices created a resource, time and network software burden for IT and technical support staff. Also, each new device could not be managed until its specific network connection information was identified and loaded on both the local device and the management application, requiring physical access to the device. Remote networkable device management, for example via the internet or over a dial-up connection, similarly required duplicate efforts for each individual and or family of devices. Operation upon remotely controlled devices was on a serial basis, one command to a single device at a time. Multiple units under remote control receive commands/data one after the other.

Manufacturers of networkable devices develop and support products, often each of the products having a separate configuration/administration product. As product lines evolve, the previous generation still requires support services for which each new generation incorporates a generally expanding range of features requiring configuration/administration.

In environments with large numbers of networked devices, configuring, maintaining, backing-up, upgrading and troubleshooting the operation and software content of/on the devices previously required individual steps/processes for each device, creating a heavy administrative burden.

It is an object of the present invention to solve these and other problems inherent with the previously available systems/software.

### SUMMARY OF THE INVENTION

Intermec Management Services (IMS), utilized by a user via a software based console, may be used on any network connected device, viewed for example, as a web page via the internet. Dynamic updating of the devices available to the console is performed by a Multicast Discovery Protocol (MDP). Multicast Remote Procedure Calls (MRPC) permit simultaneous command processing among an authorized target group of devices. A Multicast File Transfer Protocol (MFTP) permits time and bandwidth efficient one to many file transfers via a data stream at a pre-specified address which many clients simultaneously monitor. Hand shaking for the transfer is rotated among the clients so that they may each recover any lost data frames. Use of client registries for storing network data allows clients to be automatically configured upon connection to the network. Virtual monitoring and or control over the clients may be exercised from the console by executing remote procedure calls. Use of a common framework and standardized user interface allows the IMS to be readily transferred for use with both old and new devices as they emerge.

### DETAILED DESCRIPTION OF THE FIGURES

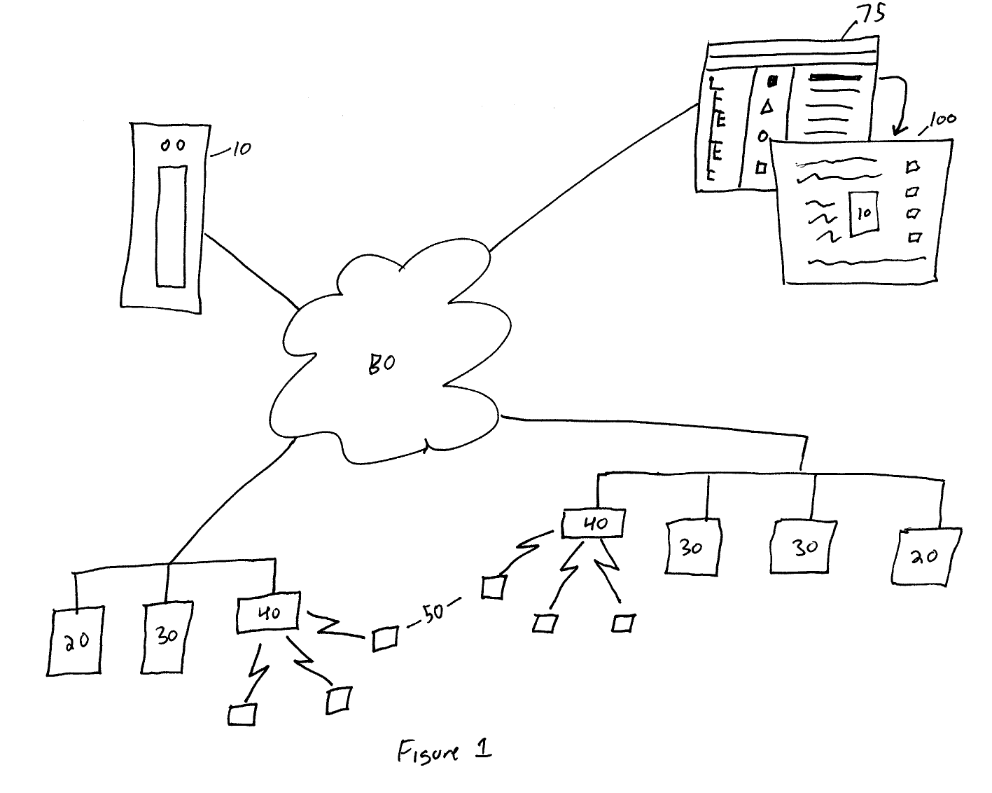

FIG. 1 is a diagram showing a sample network topology, controllable by IMS.

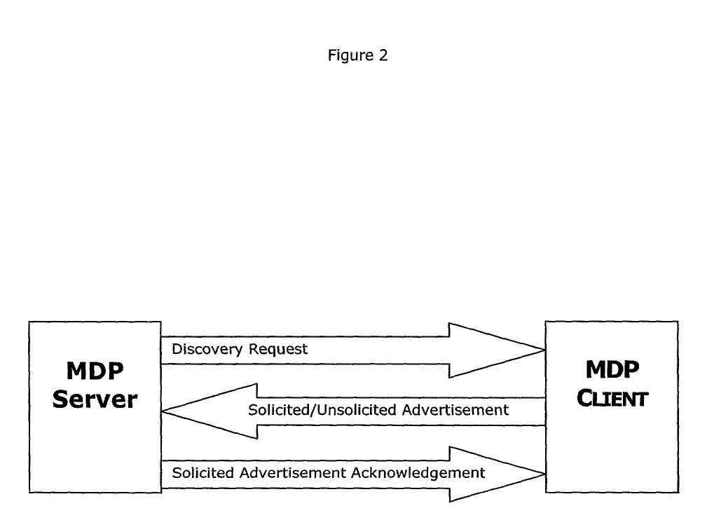

FIG. 2 is a diagram showing handshaking occurring during a MDP procedure.

### DETAILED DESCRIPTION

As shown in FIG. 1, a modern network topology can contain a plethora of different devices. The devices may comprise network server(s) 10, printer(s) 20, workstation(s) 30, proxy server(s) 40 and lower level or wireless devices 50 interconnected by the proxy server(s) 40. The interconnection between the devices may be via both local and wide area networks 80, including via the internet. The IMS provides a user with Device Management, Software Distribution and Network Management Capabilities. IMS may be a common interface, or console 75, that is used as a single interface for the user. From the console, which may appear as a browser page, the desired functionality or specific remote device may be accessed 100. To allow ready addition of new functions or device specific modules to the console, a common framework is preferred. The framework may be based, for example, on the Java 2 SDK, and may be published as an API so that all future and third party additions conform to a common application architecture, look and feel.

The preferred framework for plug-in software modules used with the invention is described in the attached Appendix A: Intermec Java Application Framework and Appendix B: Intermec Device Management User Interface Functional Specification (IDMANUI) Rev.A, both hereby incorporated by reference in their entirety.

IMS may utilize a browser plug-in for the console, enabling management of single or multiple devices from a terminal with a connection back, for example via the internet, to the network device being managed. IMS allows for configuration and monitoring of file, process, MP service and application managers as well as an event viewer and security management. Security Management including encryption keys and user password maintenance. Devices managed include any device direct or wirelessly connected to the network or devices connected to the network through proxy services for example serial/USB cradles attached to computers which in turn are attached to the network. Multiple protocols including TCP/IP, HTTP, FTP, RAPI, MCFTP, MDP and RPC protocols are used to manage the devices. With a single or multiple devices or a subgroup of devices features include device discovery and file transfer through FTP and/or multi-cast FTP, remote procedure calls, and/or remote control through a virtual device interface. Other functionality includes: operating system maintenance, upgrades and troubleshooting, application install/uninstall, configuration of devices, and cloning of devices. The registry of individual or groups of devices may be edited in real time including the ability to reset, reboot or power down the devices remotely. Process management, time services, and NT service management are available.

A mechanism is needed to allow manageable devices and device management services to find each other on a Local Area Network (LAN). Through discovery, a device identifies itself and provides relevant information to the device management servers/services (DMS) available on the network. Discovery occurs after addressing (the process by which a device obtains/is assigned a network address). Discovery can occur when a device is added to a network or when a DMS is added to the network. Discovery is the first step in device management.

MDP uses a local administrative scope multicast address to provide discovery for LANs (not the Internet). Administrative scoping, as defined by RFC 2365, is the restriction of a multicast transport based on the address range of the multicast group. RFC 2365 defines the “administratively scoped IPv4 multicast space” to be the range 239.0.0.0 to 239.255.255.255. In addition, it describes a simple set of semantics for the implementation of Administratively Scoped IP Multicast. Finally, it provides a mapping between the IPv6 multicast address classes as specified in RFC1884 and IPv4 multicast address classes. The MDP Client and Server preferably both support a configurable time to live (TTL) so they can be configured to support TTL scoping.

The MDP Server can run as an integrated component in a Device Management Service, such as a Management Console. The MDP Server can also run as a discovery service that collects device information and then publishes that information to Device Management Service subscribers running on the network.

FIG. 2 is a diagram that shows the basic dialog between a MDP Client and Server. The following is a demonstration via a ladder diagram showing the flow of messages that complete a sample MDP Server discovery transaction:

| Server | Clients | Message |
|---|---|---|
| ----------------------------------> | | Discovery Request |
| <---------------------------------- | C1 | Advertisement |
| ----------------------------------> | C1 | Acknowledgement |
| <---------------------------------- | C2 | Advertisement |
| ----------------------------------> | C2 | Acknowledgement |
| <---------------------------------- | C3 | Advertisement |
| ----------------------------------> | C3 | Acknowledgement |
| ----------------------------------> | | Discovery Request |
| <---------------------------------- | C4 | Advertisement |
| ----------------------------------> | C4 | Acknowledgement |
| ----------------------------------> | | Discovery Request |
| ----------------------------------> | | Discovery Request |
| ----------------------------------> | | Discovery Request |

| Discovery Request | Multicast Frame |
|---|---|
| Advertisement | Multicast Frame |
| Acknowledgement | Unicast Frame |
| C1 | Client 1 |
| C2 | Client 2 |
| C3 | Client 3 |
| C4 | Client 4 |

The MDP server sends a series of multicast discovery frames that contain a transaction ID (TID). Each client that receives a discovery frame with a new TID will send a multicast advertisement. The multicast advertisement will update all MDP servers within its multicast scope. When an MDP server receives an advertisement that requests an Acknowledgement (ack) and contains a TID that identifies that server, it sends a unicast ack to the client. Once the client receives an ack for an advertisement, it caches the transaction ID and will filter all subsequent discovery frames carrying that transaction ID. The caching of discovery TIDs serves two purposes. First, it provides a scalability mechanism that allows the recovery of a server that is over-run with advertisements in response to a discovery request. The server will ack the advertisements that it receives, then send another discovery frame with the same TID. All clients that received an ack for their advertisement will not send an advertisement in response to the additional discovery request. This continues until the server does not receive any advertisements in response to a discovery request. This process is a divide-and-conquer approach to discovering a large set of devices. Second, it provides a mechanism that conserves network bandwidth by not requiring all devices to respond to all discovery requests.

The following is a demonstration via a ladder diagram showing the flow of messages that complete a sample MDP client advertisement transaction:

| Server(s) | Clients | Message |
|---|---|---|
| <----------------------------------- | C1 | Advertisement |
| <----------------------------------- | C1 | Advertisement |
| <----------------------------------- | C1 | Advertisement |

Advertisement = Multicast Frame
C1 = Client 1

When a device is reset or resumed (powered on), the MDP client sends a series of unsolicited multicast advertisement frames to the network. The frames are not acknowledged. Advertisement frames can be sent on a regular interval to refresh advertisement data such as battery and memory status.

MDP allows a DMS to discover the manageable devices on the network. MDP is responsible for making a device and its attributes known to IMS so it can be remotely managed and monitored. MDP provides a routable one-to-many discovery mechanism. The protocol also provides for the discovery of proxy relationships. This allows a device that is not directly connected to the network to be discovered and managed via a proxy partnership.

The discovery exchange between the device and the DMS preferably updates the DMS with the following specifics about a non-proxied device:

1. Device name and IP address (name includes NETBIOS name and fully qualified domain name).

2. Battery status (AC power, charge and lifetime status).

3. Program and storage memory status (allocate, in use and free).

4. Processor type and number of.

5. Operating system (platform, version, build number).

6. Single URL of an XML file that describes the device in greater detail.

7. Variable length list of machines (names and IP addresses) that may provide PIM data for the device.

The IMS may use proxy servers, servers that sit between a client application and a real server or a device that is not on the network and cannot run a real server. The proxy servers intercept all requests to the real server or the device unable to run a real server to see if it can fulfill the requests itself. Proxy servers are common, for example with dockable PDA's and wireless devices.

The discovery exchange between the device and the DMS preferably updates the DMS with the following specifics about a proxy server and its associated device:

1. Proxy server name and IP address (name includes NETBIOS name and fully qualified domain name).

2. Connection status of proxied device.

3. Device name and IP address (name includes NETBIOS name and fully qualified domain name).

4. Proxied device's battery status (AC power, charge and lifetime status).

5. Proxied device's program and storage memory status (allocate, in use and free).

6. Proxied device's processor type and number of.

7. Proxied device's operating system (platform, version, build number).

8. Single URL of an XML file that describes the device in greater detail.

9. Variable length list of machines (names and IP addresses) that may provide PIM data for the device.

MDP allows a proxy server to provide real-time event notification to a DMS when the proxied device establishes or shuts down the remote connection (eg. device enters or leaves a dock/cradle).

Freshness of the device's data maintained by the DMS may be controlled in several ways:

1. Configuring the interval at which the device or proxy server sends an advertisement.

2. Configuring the interval at which the DMS sends a discovery request.

3. Both of the above. For example, the DMS sends a discovery request every 60 seconds and the devices send an advertisement every 300 seconds. This allows stationary wireless, wired network and proxied devices to maintain a “fresh” data set at the DMS. The mobile wireless devices will be able to receive only a subset of the discovery requests at best due to radio duty cycling. By sending advertisements to the DMS, these devices are able to maintain an adequate freshness of their data set while preserving battery life.

MDP provides up-front name resolution for the devices. This feature is beneficial for devices that don't run a network client. The DMS therefore maintains the name to IP Address mapping of the devices it is managing. In all cases, name resolution services are not required when communicating with a server on the device (eg. Web, FTP, RPC, Remote Control, etc.) This feature can greatly improve device connection performance and therefore, improve overall network bandwidth utilization.

The MDP preferably has the following operational requirements.

MDP will be started as a service

On startup the server will multicast discovery frames to discover devices on the network

On startup all clients will multicast advertisement frames

System level congestion control is applied to achieve high levels of scalability

During initialization, the server will send a series of multicast discovery requests. At initialization the client also sends a configurable number of multicast advertisements to inform MDP servers of its presence. These advertisements may be configured to be sent at a regular intervals to provide a “heart beat” mechanism or may be configured to be disabled once the device has been discovered. The number of requests may be determined by a configurable parameter. Another configurable parameter may set the time delay between discovery requests.

Each series of multicast discovery requests may contain a transaction ID that allows a client to filter discovery frames that have already been processed (advertisement/ack exchange). On receipt of a discovery request by a client, the client will respond by returning a unicast advertisement to the MDP server. The invention may be configured so that once the client has received an ACK for the advertisement, it will ignore further multicast discovery requests with the same transaction ID.

A system level interface provides set and get capabilities from the application layer. A configuration frame may be received from a server. The receiver responds to a “set” configuration frame by setting the parameter(s) as provided in the configuration element set. The receiver responds to a “get” configuration frame by constructing the configuration element set and sending it (unicast) to the sender.

The MDP server responds to client advertisements by logging the client and its data. The server will also send a unicast acknowledgement to the sending client. Acknowledgment frames are sent from the MDP server to the MDP client in response to Advertisement frames requesting an ACK. Acknowledgment frames are sent from the MDP Client to the MDP server after receiving a Configuration frame that “sets” the client's MDP configuration.

In the preferred embodiment, MDP parameters are saved in the registry of the MDP client and server. MDP registry parameters contain configuration and identification information. The client is therefore able to initialize itself from its registry. If the MDP registry entries don't exist (eg. after a cold boot) the client creates the registry entries and initializes them. An example set of registry parameters is listed in Appendix G. These parameters may be expanded as new requirements and device functionality's become available.

The MDP Client manages device attributes in a generic/platform independent way. It manages all device attributes as information elements. Each information element contains, for example, a 16-bit element ID, a 16-bit element length, and the element data (binary buffer). The device class provides an abstraction layer between the MDP Client and the platforms device information architecture. The device class is ported to each new device platform thereby leaving the MDP Client platform independent. The device class implements a function for each supported device attribute. The caller provides a buffer, the length of the buffer, and an optional boolean flag that indicates whether the device data should be converted to network byte order (default is true). The function will return a boolean flag indicating success or failure. If the function was successful, then the caller's buffer will contain the requested device data, and the length of the data is returned in the variable that carried the buffer length into the call.

| Frame Field | Size | Description |
|---|---|---|
| Frame Type | 4 bits (12-15) | Frame type (Discovery = 1, |
| | | Advertisement = 2, Ack = 3) |
| Version | 4 bits (8-11) | Protocol version |
| Ack Required | 1 bit (7) | Acknowledgement required |
| | | (Advertisement only) |
| Proxy | 1 bit (6) | Indicates if frame is from |
| | | proxy agent (Advertisement) |
| Connected | 1 bit (5) | If frame from proxy, indicates if |
| | | device is connected |
| Reserved | 5 bits (0-4) | Reserved for future use |
| Encrypt Algorithm | Byte (8 bits) | Specifies data encryption |
| | | algorithm |
| Encrypt Length | Word (16 bits) | Length of encrypted data |
| Encrypt Count | Byte (8 bits) | 1 = Public only, |
| | | 2 = Public/Private |
| Data | Variable Length | XML Document containing |
| | | device attributes |

The MDP frame carries data encoded in, for example, XML format. Each frame type carries an XML document that represents the type of data it is carrying. Because MDP frames may be encrypted, each frame type can be filtered (rejected) if the frame is not carrying a well-formed XML document of the appropriate type. This provides a simple mechanism for ensuring that an MDP client/server is processing frames from a valid source (same encryption key). A sample Server Discovery Frame Data Format (XML Document) is attached in Appendix C. A sample Client Advertisement Frame Data Format (XML Document) is attached in Appendix D. An actual sample of an advertisement XML document from a Compaq PDA model iPAQ H3100 with 16M of main memory is shown in Appendix E. An example of a Server Ack Frame Data Format (XML Document) is shown in Appendix F.

To permit devices configured with global positioning system (GPS) functionality to report both their presence and exact location during Discovery, Frame Data fields for the device's current GPS co-ordinates and or inertia references may be added to the XML Document. The data space needed for these fields being proportional to the desired resolution of the co-ordinates. Device location of a possibly extremely large group of remote devices is then continuously updated during the heart beat discovery advertisements. This functionality is usable for logging historical device movement and or alarming out of bounds location/speeds above preset parameters.

A Frame Handler will process all frames (Tx/Rx). Advertisement frames will be sent in response to discovery frames. Ack frames will be received after sending solicited advertisement frames. If the advertisement interval is non-zero, unsolicited advertisement frames will be sent periodically.

Frame processing may include validation (version, frame type, etc.), encryption, decryption, XML document writing (attribute fetches, encoding), XML document reading (formation validation, parsing), filtering/caching. The Winsock is a preferred network communication means. Various system APIs will be used to fetch device attributes. The client will use its own XML class to read and write documents. The client will use its cache manager to determine when to filter discovery frames. Also, a blowfish class may be used to handle the encryption/decryption of all XML documents.

Some devices may receive a discovery request from a server that is, for example, on an unauthorized subnet, or other indicator that they are unworthy; in those instances individual devices may reject control from the controlling device, for example, by choosing to not ack the request or even nack (negative acknowledgement) it.

The transaction ID (TID) cache manager maintains a history of discovery transactions. Discovery transactions are in one of two states: “in progress” or “complete”. Discovery transactions are complete if a discovery frame and Ack frame have been received with the same TID. The Frame Handler Task sends an advertisement frame for all incomplete discovery transactions and filters discovery frames associated with a completed transaction. The cache manager is responsible for creating, querying, updating, and aging the cache entries. Aging uses a simple counter method to determine the age of cache entries. This keeps the code fast, small, and portable.

The Frame Handler will process all frames (Tx/Rx). A Discovery transaction will be completed when the server starts up. To complete a discovery transaction, the server sends a discovery frame and processes all advertisement frames (sends an Ack) until a timeout occurs. Another discovery frame is sent and the advertisement frames are process until a timeout occurs. This continues until no advertisement frames are received in response to a discovery frame. All discovery frames carry the same TID and are filtered based on that TID by the clients once they have received an Ack for their advertisement. Frame processing will include validation (version, frame type, etc.), encryption, decryption, XML document writing (attribute fetches, encoding), XML document reading (formation validation, parsing), caching. The server will pass all advertisement frames to the device cache manager. The device cache manager will maintain a list of devices and a pointer to their most current advertisement frame. As new advertisement frames arrive, they are placed in a ring buffer and an event is used to signal the device cache manager. The cache manager updates the device list with the new advertisement(s) and then notifies the registered advertisement consumer (e.g. Management Console) that the device list has been updated.

Multicasting is a technique developed to send packets from one location in the Internet to many other locations, without any unnecessary packet duplication. In multicasting, one packet is sent from a source and is replicated as needed in the network to reach as many end-users as necessary. Multicasting is not the same as broadcasting on the Internet or on a LAN. In networking jargon, broadcast data are sent to every possible receiver, while multicast packets are sent only to receivers that want them. The concept of a group is crucial to multicasting. Every multicast requires a multicast group; the sender (or source) transmits to the group address, and only members of the group can receive the multicast data. A group is defined by a Class D address (see http://www.multicasttech.com/).

Scoping is the restriction of multicast data transport to certain limited regions of the Internet. It comes in two flavors, TTL scoping and administrative scoping.

Every Internet Protocol Packet has a Time To Live (TTL) field, which despite the name is really a count of the number of hops (transmission from one router to the next) the packet is allowed. The TTL field is decremented by one each time a packet leaves a router, and a packet with a TTL of zero is discarded. Although the TTL field was implemented to prevent packets from looping forever in the network, the TTL field can be set low to prevent packets from leaving a particular domain. The problem with TTL scoping is that the hop-distance to the edge of a network or domain from a given source may not be uniform, and so it may not be possible to both service the entire domain with multicast traffic and prevent that traffic from leaking to other domains, no matter what TTL value is chosen.

Administrative scoping is the restriction of multicast transport based on the address range of the multicast group as defined by RFC 2365. The use of the multicast address space is governed by RFC 3171. Administrative scoping is restricted to the address range 239/8, with the 239.255/16 address space being reserved for the “local network” (i.e., those packets should not be forwarded) and 239.192/14 is reserved for “organizational scoping.” Such large scale administrative scoping must be announced, so that others know what the scope is, which is supposed to be done by MZAP, the Multicast-Scope Zone Announcement Protocol, described in RFC 2776. Many domains will filter out all 239/8 traffic at their borders, so that any address in this range could be used for internal multicasts.

IMS uses a Multicast Remote Procedure Call (MRPC) protocol. MRPC is implemented as a protocol for client/server based on the remote procedure call model. A client makes a call to a service on a group of servers, each of which sends back a reply. The reply contains the procedure's results and possibly data generated by the called procedure. The advantage of a MRPC is concurrent execution of a remote procedure on multiple servers. In theory, the MRPC executes in about the same time that it takes a standard (unicast) RPC to complete. Also, a MRPC is potentially much more network-efficient than sequential RPCs to a group of devices.

A RPC service is a set of one or more RPC programs. A program implements one or more procedures. A procedure's functionality, parameters, return codes, and reply data are documented as part of a published interface/specification.

MRPC will use a local administrative scope multicast address to provide RPC delivery for LANs (not the Internet). Administrative scoping, defined by RFC 2365, is the restriction of a multicast transport based on the address range of the multicast group. The MRPC Client and Server preferably both support a configurable TTL so they can be configured to support TTL scoping, if desired.

The following ladder diagram shows the flow of messages that complete a “short execution” (one that completes within a reasonable timeout period, e.g. a few seconds).MRPC:

| Server | Clients | Message |
|---|---|---|
| ---------------------------------------------> | | Multicast RPC |
| <--------------------------------------------- | C1 | Unicast Reply |
| <--------------------------------------------- | C2 | Unicast Reply |
| <--------------------------------------------- | C3 | Unicast Reply |
| <--------------------------------------------- | C4 | Unicast Reply |

NOTE: A “short execution”

The following ladder diagram shows the flow of messages that complete a “long execution” (one that does NOT complete within a reasonable period, e.g. a few minutes)

| Server | Clients | Message |
|---|---|---|
| ---------------------------------------------> | | Multicast RPC |
| <--------------------------------------------- | C1 | Unicast Ack |
| <--------------------------------------------- | C2 | Unicast Ack |
| <--------------------------------------------- | C3 | Unicast Ack |
| <--------------------------------------------- | C4 | Unicast Ack |
| <--------------------------------------------- | C1 | Unicast Reply |
| ---------------------------------------------> | C1 | Unicast Ack |
| <--------------------------------------------- | C2 | Unicast Reply |
| ---------------------------------------------> | C2 | Unicast Ack |
| <--------------------------------------------- | C3 | Unicast Reply |
| ---------------------------------------------> | C3 | Unicast Ack |
| <--------------------------------------------- | C4 | Unicast Reply |
| ---------------------------------------------> | C4 | Unicast Ack |

MRPC therefore provides a mechanism (client/server based protocol) that allows a client to initiate a procedure call on select remote servers for concurrent processing and receive an individual reply from each server.

Any MRPC implementation should provide for and/or address the following:

1. Each callable procedure must be able to be uniquely identified.

2. The protocol must provide a mechanism to bind reply frames to a call frame.

3. The protocol handles errors such as version mismatches, invalid parameters, invalid parameter encoding, etc.

4. The protocol may be statically bound to UDP in order to utilize multicast addressing. Therefore, the protocol must provide timeout, retransmission, and duplicate detection mechanisms in order to guarantee at-most-once execution on each server.

5. The protocol may operate on a single local administrative scope multicast address. Since all servers will be addressable on a single group address, the protocol must provide a mechanism for selecting a target RPC subgroup.

6. Since the UDP transport protocol imposes a restriction on the maximum size of frames, the MRPC protocol preferably provides a mechanism for transitioning to TCP, which is a stream-oriented protocol (no size limit), in the cases where a reply size exceeds a given threshold.

7. The reply size threshold may be specified in the call so it can change dynamically without requiring additional communications with the servers in order to change it.

8. For calls that may take a long time to complete (e.g. upgrading the firmware on a device, system snapshot, device cloning, etc.) the call must be able to contain a request for acknowledgement (ack) before the call is executed. This will allow the client to wait for an extended period of time for a reply knowing that the specified procedure is being executed. When the server sends the reply, the call must be able to contain a request for acknowledgement. Normally the retry burden is placed on the client. If a call is made, and a reply is not received, another call is made. However, in this case the call has been acknowledged and the retransmission burden is now on the server. Therefore the server must receive an ack for the reply to ensure that the client received it. If a device management console (GUI) has initiated a call that will take a long time to complete, it would usually be desirable to show the call's progress. The protocol may limit itself to a single data encoding method.

9. The protocol may provide encryption, compression, and authentication, mechanisms and must not be limited to a single algorithm.

10. RPC frames may be encrypted with a public encryption mechanism that will provide a spoofing/protocol protection mechanism. RPC frames must also have optional private encryption that will allow a customer to secure the RPC protocol.

When an MRPC is intended to be used with large blocks of RPC reply data from the end devices, the MRPC client can specify the maximum reply size (in bytes). If the reply size exceeds the limit, the MRPC server saves the reply data in a file and returns a universal data location descripter (e.g. URL). The client can then use a HTTP or FTP function to retrieve the data as desired. Other possible triggers for using the URL return mode include detection of high data traffic and or error levels.

Used for instant messaging, an MRPC may be implemented to gather history related to a current instant message, viewed for example via a drop down menu, even if it had been previously moving between multiple users/locations. An instant message may be replied to using an MRPC to direct it to a single, multiple or a group of target recipients. To create a guaranteed delivery or receipt upon viewing by the target user or group as the case may be, an MRPC may be used to immediately send an ack that an instant message has been viewed/received.

Another example of a MRPC implementation is Multicast File Transfer Protocol (MCFTP). MCFTP is a Reliable Multicast Protocol (RMP) which reliably, efficiently and simultaneously transports data from a single sender to multiple receivers on a multicast enabled TCP/IP network. In MCFTP, one file stream is transmitted and received by many instead of repeating a unicast file transfer for each receiver. The advantages of using a multicast transfer protocol as opposed to repeating a unicast transfer protocol are shorter delivery time and conservation of network bandwidth. The protocol is a reliable file transport method, not a time bounded reliability service as required by synchronous real-time streaming applications.

MCFTP is lightweight enough for embedded devices, reliable, scalable, secure, configurable and efficient in a wide variety of network environments, for example, networks that contain wireless devices. MCFTP is UDP based, thereby allowing IP Multicasting to be used as its delivery system. Frames may be addressed to a group of devices. The network forwards these frames to only the subnets with devices that are members of the group (via routers and IGMP). By contrast, UDP is a datagram service and does not guarantee data reliability. MCFTP provides a data transport layer above UDP and IP Multicasting services. The functions of the transport layer include handshake-based session control and transport reliability based on block sequencing, timeouts, and retransmissions.

A MCFTP server transfers a file by first announcing the file on a public multicast address. To ensure that all intended devices notice the announcement, file announcements are preferably sent to only a single (configurable) public multicast address. In embodiments with a large number of diverse clients and or sessions, multiple public multicast addresses may be used, providing a first filter layer between the target clients. A client that is granted a session is informed of the private IP multicast address and UDP port that will be used. The use of a separate IP address for each transfer prevents the inadvertent mixing of file streams that could cause file corruption. The protocol provides data transport reliability to IP multicast. This reliability is provided through address management, handshake-based session control and retransmissions.

A remote storage path may precede the file name contained in the file announcement. This controls where the clients will store the file. This will allow for remote installations based on Microsoft Corporation's current method of application installation, installing a profile to a subdirectory. The server is able to replicate a directory tree on the clients by specifying the full path of each file relative to the remote destination. The client will create any necessary subdirectories that do not exist in the path. It is preferred that all transferred files maintain the original time stamp from the server.

MCFTP is ACK/NAK based. In response to the file transfer announcement, each client requests a session with the server. Clients that are granted a session are informed of a server selected private multicast address and port where the transfer will occur. The server then sends multicast frames to the private multicast address (that the authorized receivers have joined) and receives ACKs from a designated member of the group known as the initial Master Client. After the initial Master Client has lock-stepped through the file, all other devices are given a turn as Master Client at which time any missed data frames identified by the current Master Client are NAKed and retransmitted as multicast frames by the server.

MCFTP provides for over-run recovery. The data rate is dynamically adjusted by the ACK rate of the Master Client. The receiving group will automatically control its highest possible data rate as the group changes and as network conditions change. The clients are configured with an over-run frame interval and percent lost threshold. Devices evaluate their over-run status based on their configured interval and threshold. Once a device determines that it is being over-run, it can send an indication to the server. This mechanism allows the most severely over-run client to NAK the blocks it missed and then assume the role as the new master client.

MCFTP allows for any client to leave the transfer by sending an error frame to the server. The protocol also allows late-joins. The server periodically announces the file transfer during the transmission, so late-joining hosts may request a session.

All receivers keep a bitmap of the block numbers successfully received. Each frame that is received is checked against this bitmap and the duplicates are filtered. The initial Master Client lock-steps through the file so the packets are sent and received in order. The passive clients may receive the packets out of order because all non-duplicate packets are written to a file offset where offset=(block number−1)* block size. If any data is missed (holes exist in the file), the device will use the block-number-bitmap to determine which packets to NAK when it is elected Master Client.

Rudimentary congestion control is provided by a flow control mechanism and the protocol's method of synchronizing the file transfer. Synchronization starts all clients receiving together in an attempt to reduce the number of packets that will be retransmitted. Known multicast protocols must be designed to reduce or avoid NAK implosion, MCFTP eliminates NAK implosion with the Master Client model. A TCP/IP network is dependent on the TCP congestion control mechanisms which allow all connections to share bandwidth fairly. Even though the protocol is delivering a file to many host simultaneously, at any given time, it is nothing more than a flow controlled point-to-point transfer that has many passive listeners collecting data from the stream. The protocol's lock step mechanism will help prevent the protocol from contributing to adverse network conditions such as congestion collapse. It also helps maintain protocol compatibility with congestion avoidance algorithms employed by devices such as Random Early Detection (RED) gateways. Controlling the maximum frame size at the protocol level, provides the option for globally tuning the protocol in wireless networks without having to change MAC level parameters on the end devices. Pipelining is the process of sending multiple frames before an ACK is required. The protocol's lock-step mechanism does not always allow the highest possible data rate to be achieved. A pipelining mechanism is provided to increase the data rate when the network can support higher bandwidth. Pipelining is provided by the fragmentation and re-assembly services of the IP protocol. This allows the server to send one large block of data, which IP fragments and sends as multiple frames. After IP re-assembly, the client then receives one large block of data which it ACKs. The fragmentation threshold (block size) is configurable.

It is preferred that, in MCFTP, the protocol (not just the data) is secured via encryption, for example the Blowfish encryption algorithm (variable-length key, 64-bit block cipher). In the preferred embodiment, the key is not negotiated over the network. Clients are Authenticated by being able to decrypt/encrypt the protocol successfully.

The server is aware on every MCFTP transfer which hosts successfully completed the transfer and which hosts did not. When the server announces a file, the transfer size is indicated and a client that does not have sufficient space to store the file will send a “Disk full or allocation exceeded” error to the server and not request a session. All other clients request a session that completes successfully, is denied or fails.

For peer to peer transfers, the IMS may use standard file transfer protocol (FTP) through the interface in a drag and drop format from the desktop. Copy, move, delete and rename functionality is available. By issuing, for example, a right mouse click on the tree representation of available devices shown in the browser an individual device's web page may be launched with the selected device's IP address. When viewing a device's file tree, ftp may be implemented in a drag and drop copy and or move file mode.

Other MRPCs may be performed in multi-cast fashion to create a process, terminate a process, perform a warm boot, set the clock, operate upon the registry, set attributes, create or remove directories and copy or move/delete files. Operating upon the registry, Multi-cast procedure calls may edit, create, and/or delete registry keys and get, set, and/or delete registry values. Single or multiple devices may be run virtually from the IMS console. Virtual remote control allows a complete hands-on real time or via script control to run applications, view error messages, record/playback macros, view configuration data all in a resizable virtual screen representing a single or multiple remote machines. Surveillance, quality control, activity logging and/or education plug-ins may use the virtual remote control capabilities of IMS.

To enhance real time responsiveness and minimize network bandwidth requirements, the responses of a remote device or the detailed commands to a device may be coalesced. Rather than sending a network packet with each, for example change of mouse position and or keystroke, data state change the changes may be collected and then sent in combined network packets at a set interval. The configurable coalescing interval being, for example, the selected screen update frequency when operating with a device under virtual remote control. If the network is overloaded, the coalescing interval may be extended to assist in overload reduction without requiring termination of the individual process(s).

IMS's MRPC capabilities may be used to upgrade a full operating system upon a single device or multiple devices. Subgroups for upgrading may be selected from all of the devices. Once new files are transferred, the devices may be rebooted remotely to initiate the new upgrade. A script transmitted to a potentially huge group of devices may be used to initiate, for example mouse location and button actions which can execute operations within programs or web pages.

The invention services may be configured with respect to time. Every selected device may be synchronized to a common time merely by selecting the present time on the console machine.

MRPC calls may include sub-group creation to implement commands only within a sub-group of the whole group. For example, this would allow machines missing a required file or procedure execution to obtain/perform the missing requirement in order to bring the sub-group up to “par” with other members of the group which had already performed the requirement. Scheduling of previously listed services for off-peak periods or repeating back-ups may be performed. The IMS framework allows the IDM to drill down to a specific device and the specific configurable options of the given device. Available devices may be accessed from a list in a graphical tree form from which a specific device is selected and various options available for that device then viewed and modified.

An example of a specific interface for a family of devices to the network is the low cost gateway. The low cost gateway allows a wide range of legacy products to be connected to a network for ultimate control by the invention. The low cost gateway is described in detail in the “Low Cost Gateway Functional Product Specification” hereby incorporated by reference. Reasoning and feature application for the low cost gateway is described in “Intermec Layered Host Gateway Product Marketing Requirements Rev.A” hereby incorporated by reference. Another example of an IMS plug-in is the “Intermec Management Services GUI IDRS Navigation Plug-in Functional Specification Rev.D” (INAV), attached hereto as Appendix H. The INAV plug-in provides navigation support as well as read and write access for devices in the IDRS database. The IDRS database is a registry of known network devices and their characteristics/capabilities. The INAV acts as the interface for the IDRS with the run time server, the IMS console and any other plug-ins that may be present. INAV is configurable to view either a specific device or a tree of devices in either standard or custom views. Use of the framework allows the INAV to appear seamlessly within IMS.

The invention is entitled to a range of equivalents and is to be limited only by the following claims.

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

We claim:

1) A method for discovering the presence of clients connected to a network, comprising the steps of:
broadcasting a discovery request from a server, across a network;
receiving the discovery request at a client connected to the network and returning an advertisement to the server containing an identification of the client;
receiving the advertisement at the server and sending an acknowledgement to the client.

2) The method of claim 1, further including the steps of:
sending an advertisement at configurable intervals from the client to the server whereby the server maintains the client as a known and active device in a list of known and active devices.

3) The method of claim 1, further including the steps of:
upon receiving the acknowledgement, the client stores a transaction identifier,
the client then comparing the transaction identifier against any future discovery requests received, whereby future discovery requests by the same server are ignored for a configurable interval.

4) The method of claim 1, wherein:
the advertisement identifies client characteristics comprising;
a device name and network address,
a power status,
a program and storage memory status,
a processor type,
an operating system type, and
a memory location identifier for a memory location containing data with further device details.

5) The method of claim 1, wherein:
a proxy server acts as an interface between the client and the server.

6) The method of claim 1, wherein:
data defining a protocol for the clients interaction with the server is stored in a client registry.

7) The method of claim 1 wherein the advertisement is encoded in a frame format containing client attribute data in an xml document.

8) A method for executing a multi-cast remote procedure call, comprising the steps of;
broadcasting a remote procedure call, across the network;
receiving the remote procedure call at a client connected to the network and returning a reply to the server with one of a confirmation of an execution of the remote procedure call and a data frame containing data related to the execution of the remote procedure call.

9) The method of claim 8, wherein:
if the data frame would be required to be larger than a configurable size, the data is saved in a file and a universal data location descriptor, identifying the file is returned.

10) A method for data transfer to a plurality of clients across a network, comprising the steps of;
announcing the data transfer on a public multi-cast address,
receiving an acknowledgement each from a plurality of clients desiring to receive the data transfer,
designating a master client from the plurality of clients,
transmitting the data transfer to a network address accessible to the plurality of clients at a data rate less than a maximum data read rate of the master client,
requesting retransfer by the master client after completion of the data transfer of any data blocks that were not received,
transferring master client designation to another of the plurality of clients when the master client has all data blocks of the data transfer,
requesting retransfer of any data blocks not received by the next master client,
transferring master client designation among all clients in turn, until each has had the opportunity to request any missing data blocks.

11) A system for universal network device management, comprising:
a server operable on a network having a software console,
a plurality of network interfaces, using a common API, associated with a plurality of devices connected to the network,
the network interfaces configured to identify their associated device to the server,
the software console and network interfaces arranged to enable virtual control of one of an individual device, a group of devices, and all of the devices connected to the network.

12) The system of claim 11 further including a proxy server representing devices on the network which do not have means for an individual network connection.

13) The system of claim 11, wherein the software console is a web page operable remotely from the server via a browser.
